(19) United States
(12) Patent Application Publication
(10) Pub. No.: US 2015/0058170 A1
(43) Pub. Date: Feb. 26, 2015

(54) DIGITAL SIGNAGE SYSTEM, DIGITAL SIGNAGE, ARTICLE INFORMATION PRESENTING METHOD AND PROGRAM

(71) Applicant: NEC Corporation, Tokyo (JP)

(72) Inventors: Tomoyuki Osaka, Tokyo (JP); Toshihiko Hiroaki, Tokyo (JP); Toshiyuki Nomura, Tokyo (JP); Hiroo Harada, Tokyo (JP)

(21) Appl. No.: 14/389,442

(22) PCT Filed: Mar. 28, 2013
(86) PCT No.: PCT/JP2013/059216

§ 371 Date: Sep. 30, 2014

(30) Foreign Application Priority Data
Mar. 30, 2012 (JP) 2012-079082

(51) Int. Cl. G06Q 30/06

(52) U.S. Cl. CPC G06Q 30/0641; G06Q 30/0623; G06Q 30/0627
USPC 705/26.63; 705/26.61

(57) ABSTRACT

The present invention is digital signage comprising: an article information database in which a feature of an article and article information for the article associated with each other are stored; feature extracting means for extracting a feature from a wearing image that is an image of a customer wearing an article; comparison means for comparing the extracted feature with features stored in the article information database and identifying the article the customer is wearing; article information retrieving means for retrieving article information for the identified article from the article information database; and output control means for outputting the retrieved article information and the wearing image.

### TECHNICAL FIELD

The present invention relates to a digital signage system, digital signage, an article information presenting method, and a program.

### BACKGROUND ART

Digital signage, which is an advertising medium displaying advertisements using a display such as a liquid crystal display or a projector, has begun to be installed in a variety of places. By using the digital signage, rich contents using video and sound may be provided, and in addition, efficient advertising is achieved according to a place where the digital signage is installed, so that the digital signage market is expected to grow in the future.

When purchasing a product, a certain number of products are often tried on before purchasing. Thus, to compare appearances in trying on clothes, a customer may be allowed to capture an image of an appearance of the customer him/herself trying on clothes, and compare a plurality of captured images with one another, which process is disclosed as an invention in PTL 1.

The invention in PTL 1 involves inputting signals detected from a sensor for detecting an object to be imaged, and displaying a video captured by a camera in left and right portions of a display. It is an invention for, once a left or right button in an operating section is pressed, inputting an operative signal to display a still image in the left or right portion of the display. Thus, a customer can easily capture an image of him/herself trying on an item by him/herself, and compare appearances of him/herself trying on clothes from a plurality of captured images.

### CITATION LIST

### Patent Literature

PTL 1: JP P2011-40953A

### SUMMARY OF INVENTION

### Technical Problem

On the other hand, a customer usually desires to acquire product information on a product he/she is trying on, such as, for example, information on the color, size, and stock.

Although the invention in PTL 1 makes it possible to capture a trying-on image, it merely displays the image on a display as-is, and cannot display product information for the product he/she is trying on. This is because it does not have a function of identifying the product he/she is trying on.

Moreover, it is often a case that a customer does not make a purchase on the spot but purchases the product later after consideration. In such a case, consideration would be facilitated when the customer has a trying-on image capturing him/herself trying on the product to hand. Further, it would be more convenient when product information for the product, in addition to the trying-on image, is available.

Furthermore, it has been desired to have digital signage with functions other than the function as the mere advertisement display means.

Thus, the present invention has been made in view of such problems, and its object is to provide a digital signage system, digital signage, an article information presenting method, and a program capable of conveniently providing article information for customers purchasing products.

### DISCLOSURE OF THE INVENTION

The present invention is a digital signage system comprising: an article information database in which a feature of an article and article information for said article associated with each other are stored; feature extracting means for extracting a feature from a wearing image that is an image of a customer wearing an article; comparison means for comparing said extracted feature with features stored in said article information database and identifying the article said customer is wearing; article information retrieving means for retrieving article information for said identified article from said article information database; and output control means for outputting said retrieved article information and said wearing image.

The present invention is digital signage comprising: an article information database in which a feature of an article and article information for said article associated with each other are stored; feature extracting means for extracting a feature from a wearing image that is an image of a customer wearing an article; comparison means for comparing said extracted feature with features stored in said article information database and identifying the article said customer is wearing; article information retrieving means for retrieving article information for said identified article from said article information database; and output control means for outputting said retrieved article information and said wearing image.

The present invention is an article information presenting method in a digital signage system having an article information database in which a feature of an article and article information for said article associated with each other are stored, said method comprising: extracting a feature from a wearing image that is an image of a customer wearing an article; comparing said extracted feature with features stored in said article information database and identifying the article said customer is wearing; retrieving article information for said identified article from said article information database; and outputting said retrieved article information and said wearing image.

The present invention is a program for a computer system having an article information database in which a feature of an article and article information for said article associated with each other are stored, said program for causing a computer to execute the processing of: extracting a feature from a wearing image that is an image of a customer wearing an article; comparing said extracted feature with features stored in said article information database and identifying the article said customer is wearing; retrieving article information for said identified article from said article information database; and outputting said retrieved article information and said wearing image.

### Advantageous Effects of Invention

The present invention makes it possible to recognize an article a customer is wearing from a captured customer's wearing image, and therefore, article information may be conveniently provided for customers purchasing products.

### BRIEF DESCRIPTION OF DRAWINGS

FIG. 1 is a configuration diagram of a digital signage system in an embodiment of the present invention.

FIG. 2 is an appearance view of digital signage 1 in an exemplary embodiment of the present invention.

FIG. 3 is a configuration diagram of the digital signage 1.

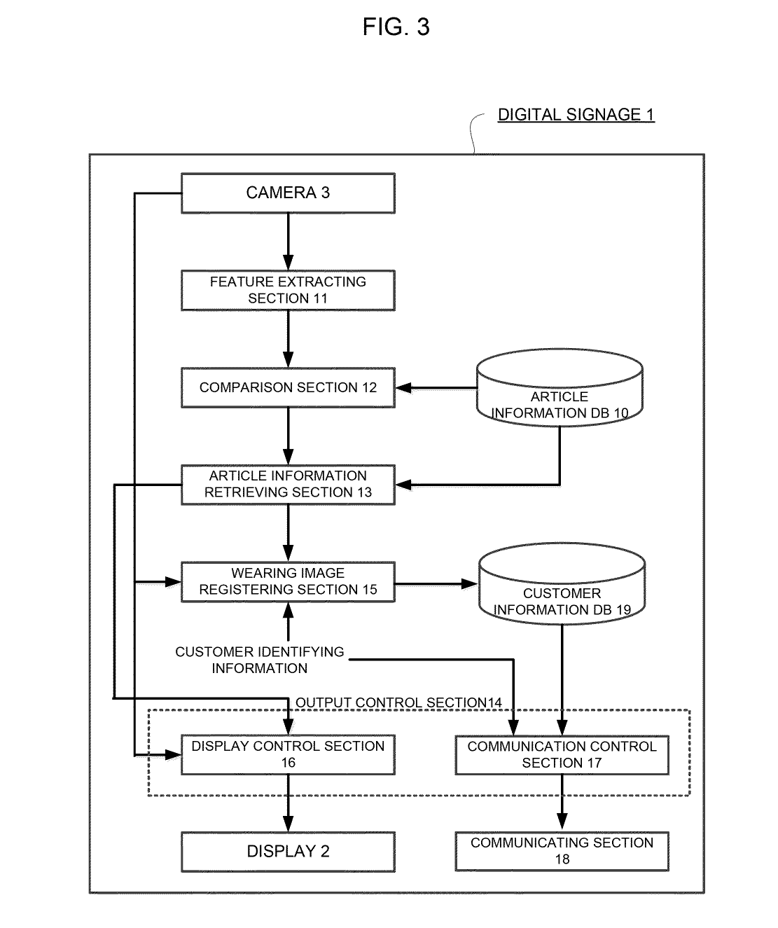

FIG. 4 is a diagram showing an example of an article information database 10.

FIG. 5 is a diagram showing an example of a customer information database.

FIG. 6 is a diagram explaining an operation of the present exemplary embodiment.

FIG. 7 is a diagram explaining an operation of the present exemplary embodiment.

FIG. 8 is a diagram explaining an operation of the present exemplary embodiment.

FIG. 9 is a diagram explaining an operation of the present exemplary embodiment.

FIG. 10 is a diagram explaining an operation of the present exemplary embodiment.

FIG. 11 is a diagram explaining an operation of the present exemplary embodiment.

FIG. 12 is a configuration diagram of another exemplary embodiment of the present invention.

FIG. 13 is a configuration diagram of another exemplary embodiment of the present invention.

FIG. 14 is a configuration diagram of another exemplary embodiment of the present invention.

### DESCRIPTION OF EMBODIMENTS

Now, embodiments of the present invention will be described.

An embodiment of the present invention causes an article a customer is wearing, such as clothes, jewelry or the like, to be identified from a wearing image of the customer wearing the article. It is also directed to digital signage for providing article information for the identified article and the wearing image to the customer.

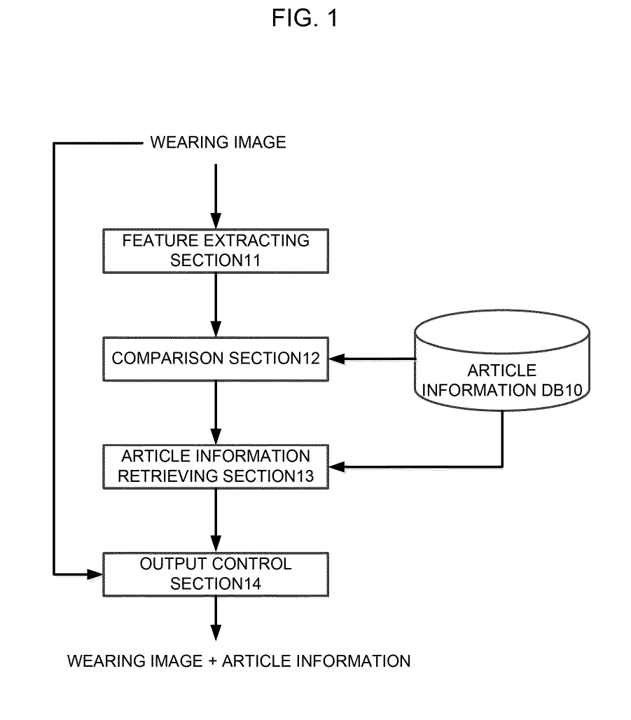

FIG. 1 is a configuration diagram of a digital signage system in the present embodiment.

As shown in FIG. 1, the digital signage system comprises an article information database 10, a feature extracting section 11, a comparison section 12, an article information retrieving section 13, and an output control section 14.

The article information database 10 is a database of information regarding articles supplied by a shop in which digital signage is installed or by whole chain stores.

The feature extracting section 11 is for extracting a feature of an article a customer is wearing from a customer's wearing image captured by a camera.

The comparison section 12 compares the feature extracted by the feature extracting section 11 with features of the articles stored in the article information database 10 to identify the article in the wearing image.

The article information retrieving section 13 retrieves article information corresponding to the article identified by the comparison section 12 from the article information database 10. It then outputs the retrieved article information to the output control section 14.

The output control section 14 outputs the wearing image and article information to output means such as a display. It should be noted that the wearing image and article information may be transmitted to a customer's terminal (a cell phone or a smart phone, for example).

As described above, the present embodiment makes it possible to recognize an article a customer is wearing from a captured customer's wearing image, and therefore, article information may be conveniently provided for customers purchasing products.

Next, an exemplary embodiment of the present invention will be described. In the following description, to facilitate understanding, an article is exemplified by a product that a supplier (shop) is currently supplying.

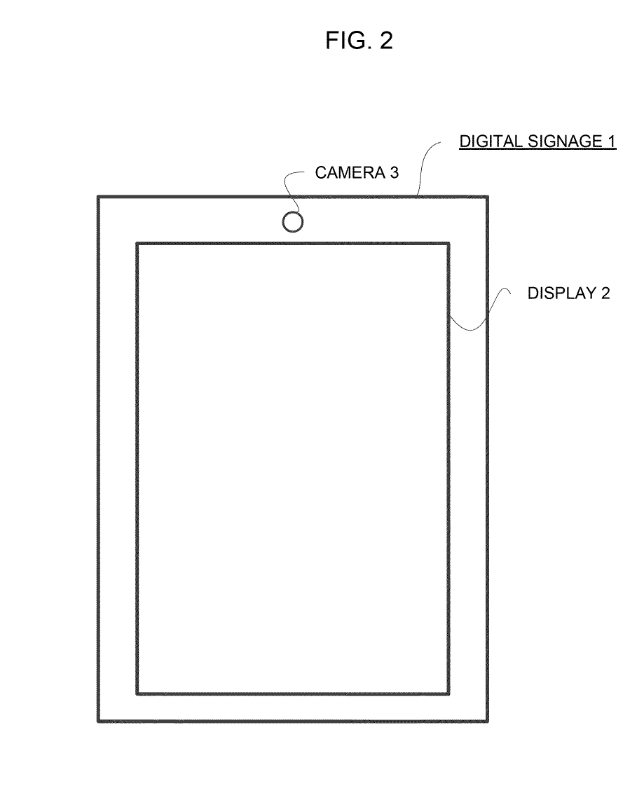

FIG. 2 is an appearance view of digital signage 1 in the present exemplary embodiment.

As shown in FIG. 2, the digital signage 1 is installed in a shop or the like, and ordinarily displays an advertising image/video using a display 2. The digital signage 1 is also provided with, in addition to the display 2 replaying the advertising image/video, a camera 3 for capturing a wearing image of a customer wearing (trying on) clothes or the like.

FIG. 2 is a configuration diagram of the digital signage 1.

As shown in FIG. 2, the digital signage 1 comprises a display 2, a camera 3, an article information database 10, a feature extracting section 11, a comparison section 12, an article information retrieving section 13, an output control section 14, a wearing image registering section 15, a communicating section 18, and a customer information database 19.

The article information database 10 is a database of information regarding articles supplied by a shop in which the digital signage 1 is installed or by whole chain stores. In particular, the article information database 10 has a product feature table 101 and a product information management table 102.

The product feature table 101 is a table for storing therein product identifying information for identifying a product associated with an image feature for the product.

The product information management table 102 is a table for storing therein the aforementioned product identifying information associated with product information regarding the product. The product information here may include the color variation and size of the product, and in addition, stock information, an attractive point, and the like.

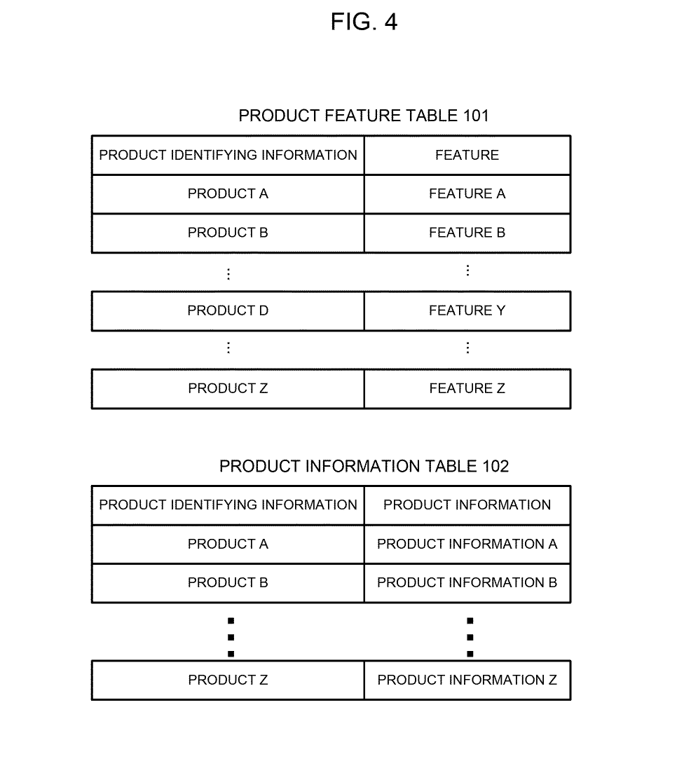

FIG. 4 is a diagram showing an example of the article information database 10. The product feature table 101 shown in FIG. 4 stores therein product identifying information associated with a feature of the product; for example, product identifying information “Product A” and a feature “Feature A” are associated with each other. The product information management table 102 stores therein product identifying information associated with product information for that product; for example, product identifying information “Product A” and product information “Product information A” are associated with each other.

While according to the present embodiment, the article information database 10 is comprised of two tables: the product feature table 101 and product information management table 102, the present invention is not limited thereto. For example, the database 10 may be comprised of one table having the product feature associated with the product information.

The feature extracting section 11 is for extracting a feature of a product a customer is wearing from a customer's wearing image captured by the camera 3. Although an article is preferably captured in an image at a predetermined position in order to facilitate the method of extracting a feature from the image, this is difficult for digital signage installed in a shop or the like. Thus, to make a product a customer is wearing within an image robustly identifiable against variation in image capture size and angle, and occlusion, a multiplicity of characteristic points (feature points) within an image are detected, and surrounding each feature point, a feature (local feature) is detected in a local region. Typical methods therefor are disclosed in Patent Document (U.S. Pat. No. 6,711,293), and Non-patent Document (“Distinctive image features from scale-invariant keypoints” by David G. Lowe, International Journal of Computer Vision, 60(2), pp. 91-110 (2004)), wherein a local feature extracting apparatus using a SIFT (Scale Invariant Feature Transform) feature is disclosed. Moreover, a method for reducing the data size of the feature may be contemplated to comprise: detecting feature points within an image; acquiring a local region for each feature point; dividing each local region into a plurality of sub-regions; generating a feature vector in a plurality of dimensions for each sub-region within each local region; based on a positional relationship between sub-regions within each local region, selecting a dimension from said feature vector for each sub-region so that a correlation with a feature vector in a proximate sub-region is lowered; and defining an element in the selected dimension as a feature for that local region.

The comparison section 12 compares a feature extracted by the feature extracting section 11 with features of products stored in the product feature table 101 in the article information database 10 to identify a product in the wearing image captured by the camera 3. According to the present exemplary embodiment, an item of the product in the wearing image is identified, and in addition, a size such as “S”, “M”, or “L” of the product, for example, is also identified. Then, it outputs product identifying information having a matching feature to the article information retrieving section 13.

The article information retrieving section 13 receives product identifying information from the comparison section 12, and retrieves product information corresponding to the product identifying information from the product information management table 102. Then, it outputs the retrieved product information to the wearing image registering section 15.

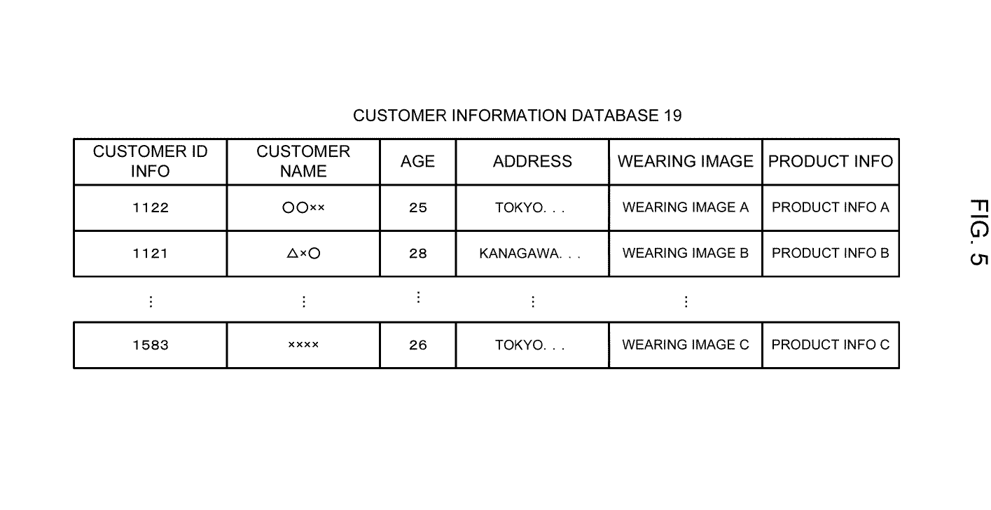

The customer information database 19 is a database in which customer identifying information, and customer information including the customer's name, age, address, and the like are registered. Further, the customer information database 19 includes a field for registering a wearing image, and a field for registering product information to allow the above-described wearing image and product information to be registered in association with the customer information for that customer. FIG. 5 is a diagram showing an example of the customer information database 19. In FIG. 5, the customer identifying information, name, age, address, wearing image, and product information are registered in association with one another.

The wearing image registering section 15 registers a customer's wearing image (in which the customer is trying on the product) captured by the camera 3 and product information retrieved by the article information retrieving section 13 into the customer information database 19 in association with the customer information for that customer. It should be noted that the customer identifying information is acquired by the wearing image registering section 15 that displays a screen for inputting customer information on the display in the digital signage 1 while the customer is wearing (trying on) the product, and prompts the customer to input his/her customer identifying information.

The output control section 14 has a display control section 16 and a communication control section 17.

The display control section 16 conducts control for displaying a customer's wearing image captured by the camera 3 on the display 2, and displaying product information for a product the customer is wearing (trying on) retrieved by the article information retrieving section 13. It also conducts control for displaying ordinary advertisements, announcement of events, and so forth on the display 2.

The communicating section control section 17 retrieves a wearing image and product information associated with the input customer identifying information from the customer information database 14, and outputs the wearing image and product information to the communicating section 18.

The communicating section 18 transmits a wearing image to a customer's terminal (a cell phone or a smart phone, for example) via a communication. It should be noted that a method of communication may be through contactless Bluetooth (a registered trademark) or the like, or alternatively, the wearing image and product information may be attached to an e-mail for transmission to any available e-mail address of the customer.

Next, a specific operation of the present embodiment in the above-described configuration will be described. In the following description, the article information database 10 and the customer information database 19 have the arrangements shown in FIGS. 4 and 5, respectively.

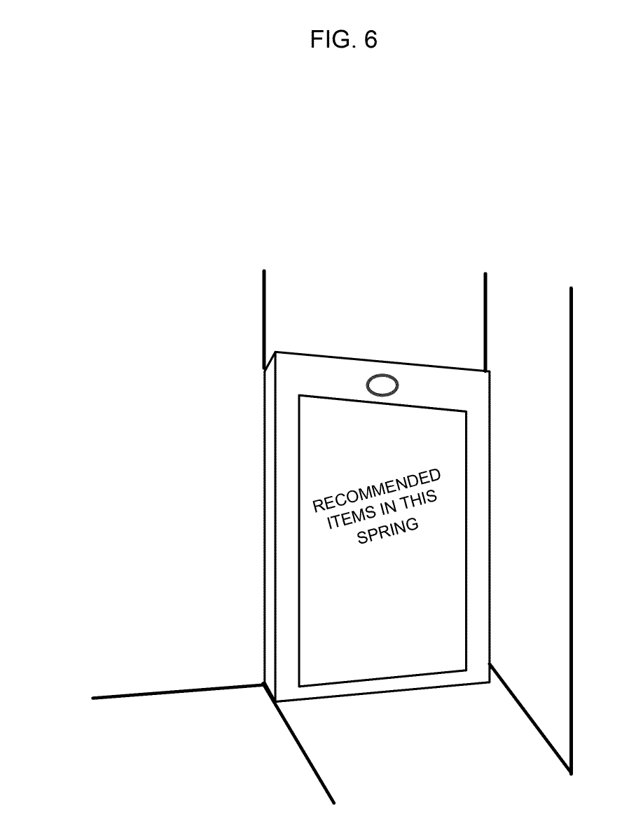

The digital signage 1 is installed in a fitting room or the like, and ordinarily, that is, for example, when no customer is standing in front of the digital signage 1, it displays advertisements of products, announcement of events, and so forth on the display 2, as shown in FIG. 6.

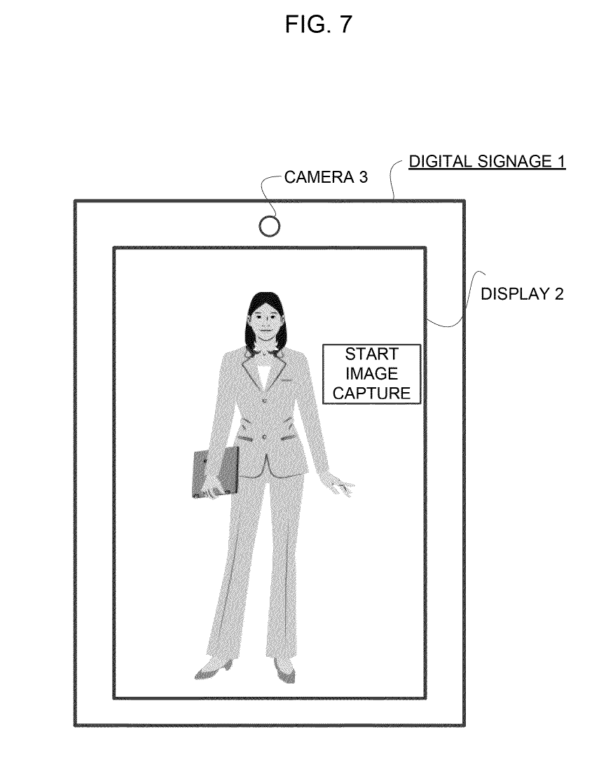

When a customer stands in front of the digital signage 1, it recognizes that the object is a person through facial recognition or the like, and a customer's image captured via the camera 3 is displayed on the display 2, as shown in FIG. 7. Moreover, a touch panel for starting image capture is also displayed on the display 2 while the customer is putting on (trying on) his/her desired clothes.

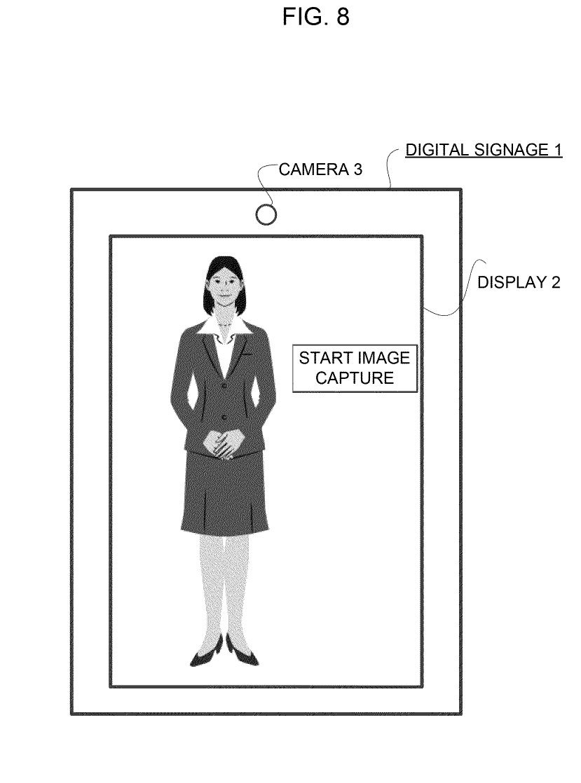

As shown in FIG. 8, once the customer has completed wearing (trying-on) and pressed the touch panel for starting image capture, capture of a customer's wearing image by the camera 3 is initiated.

Subsequently, from the customer's wearing image captured by the camera 3, a feature of the product the customer is wearing (trying on) is extracted by the feature extracting section 11. In the present example, a feature that can be extracted of the product the customer is wearing (trying on) is assumed to be “Feature A”.

The comparison section 12 retrieves product identifying information corresponding to “Feature A” extracted by the feature extracting section 11, from the product feature table 101. In the present example, product identifying information corresponding to the feature “Feature A” from the product feature table 101 in FIG. 4 is “Product A”.

Subsequently, the article information retrieving section 13 receives the product identifying information from the comparison section 12, and retrieves product information corresponding to the product identifying information from the product information management table 102. Since in the present example, the product identifying information from the comparison section 12 is “Product A”, “Product information A” is retrieved as product information associated with “Product A”. The article information retrieving section 13 then outputs the retrieved product information to the wearing image registering section 15 and to the output control section 16. Since in the present example, the retrieved product information is “Product information A”, “Product information A” is output to the wearing image registering section 15 and to the output control section 16.

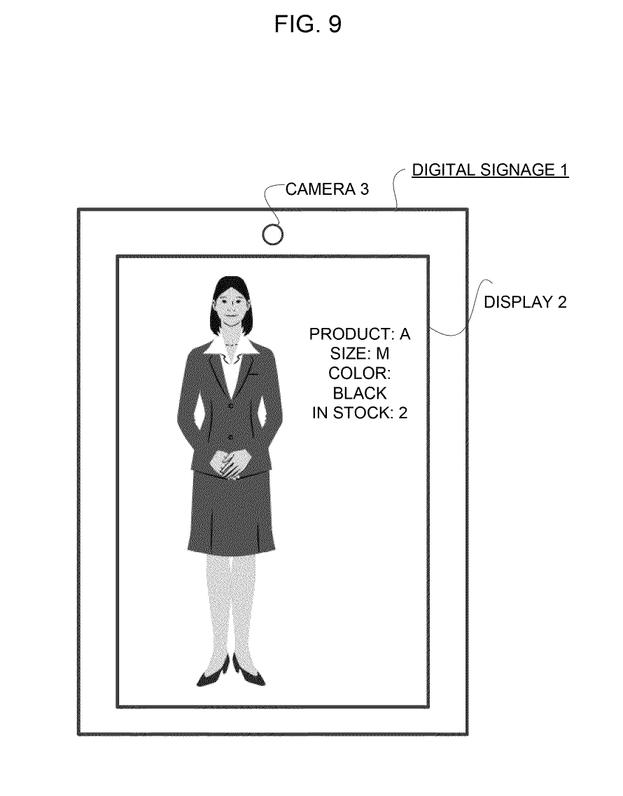

The output control section 16 displays the wearing image captured by the camera 3 and the product information for the product the customer is wearing (trying on) on the display 2. FIG. 9 is a diagram showing a condition in which the wearing image and the product information A for the product the customer is wearing (trying on) are displayed on the display 2.

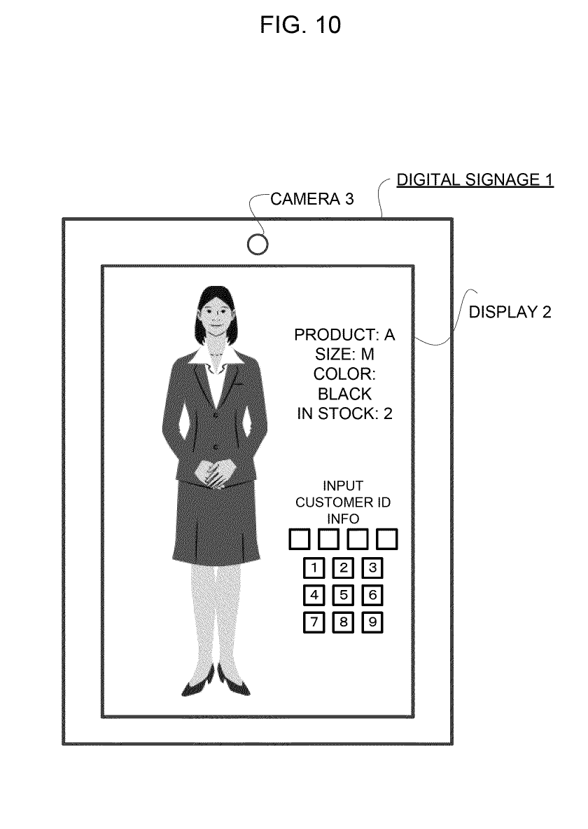

After a certain period of time has elapsed, as shown in FIG. 10, a touch panel for inputting customer identifying information is displayed for acquiring the customer identifying information. Once the customer has input customer identifying information, it is transmitted to the wearing image registering section 15 and communication control section 17. In the present example, the customer identifying information input by the customer is assumed to be “1122”.

The wearing image registering section 15 registers the wearing image captured by the camera 3 and the product information received from the article information retrieving section 13 to a wearing image field and a product information field in the customer information database 14 corresponding to the customer identifying information input by the customer. In the present example, “Wearing image A” captured by the camera 3 is registered in the wearing image field and “Product information A” is registered in the product information field of a record having customer identifying information “1122”.

The communication control section 17 reads a wearing image and its product information corresponding to the customer identifying information from the customer information database 14, and outputs them to the communicating section 18. Since in the present example, the customer identifying information is “1122”, “Wearing image A”, and “Product information A” are read from the customer information database 14 and output to the communicating section 18.

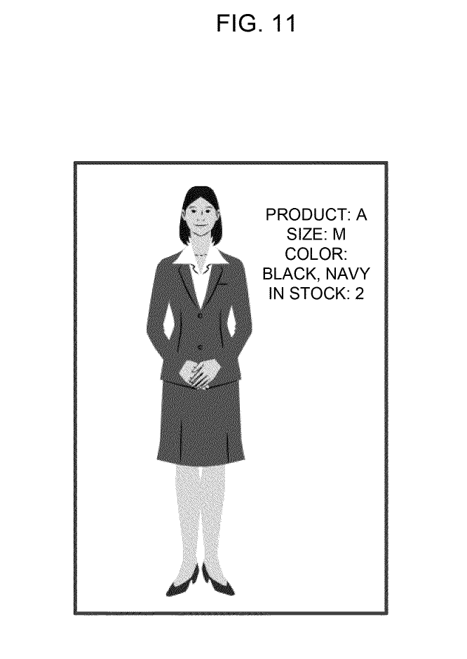

The communicating section 18 transmits the wearing image and product information received from the communication control section 17 to a customer's terminal. In the present example, the communicating section 18 transmits “Wearing image A” and “Product information A” to the customer's terminal FIG. 11 shows an example of the wearing image and product information for the product the customer is wearing (trying on) transmitted to a customer's terminal.

As described above, the digital signage 1 in the present embodiment identifies a product a customer is wearing (trying on) from a captured customer's wearing image, and automatically displays product information of the product the customer is wearing. Accordingly, a customer can acquire product information regarding a product the customer is wearing (trying on).

Further, since such wearing image and product information can be transmitted to a customer's terminal, they can be reviewed for reference when the customer may purchase the product later. Especially when the customer visits the shop later, and product information is displayed, a size-based forward stock database may be referred to to inform the customer of whether any product with desired size is in stock. It should be noted that the size of a product may be identified by a feature as described above, or may be selected by the customer as product information. The information is registered in the customer information database 19 as customer information. Moreover, for a shop that issues a customer card or the like, the information may be recorded on the customer card.

Moreover, when the customer purchases that product later, and in a case that he/she shows his/her wearing image, the information may be used in an event, for example, an event offering the customer bonus such as discount.

While in the present embodiment, a wearing image and product information for a product a customer is wearing (trying on) are transmitted to a customer's terminal, only a wearing image may be transmitted.

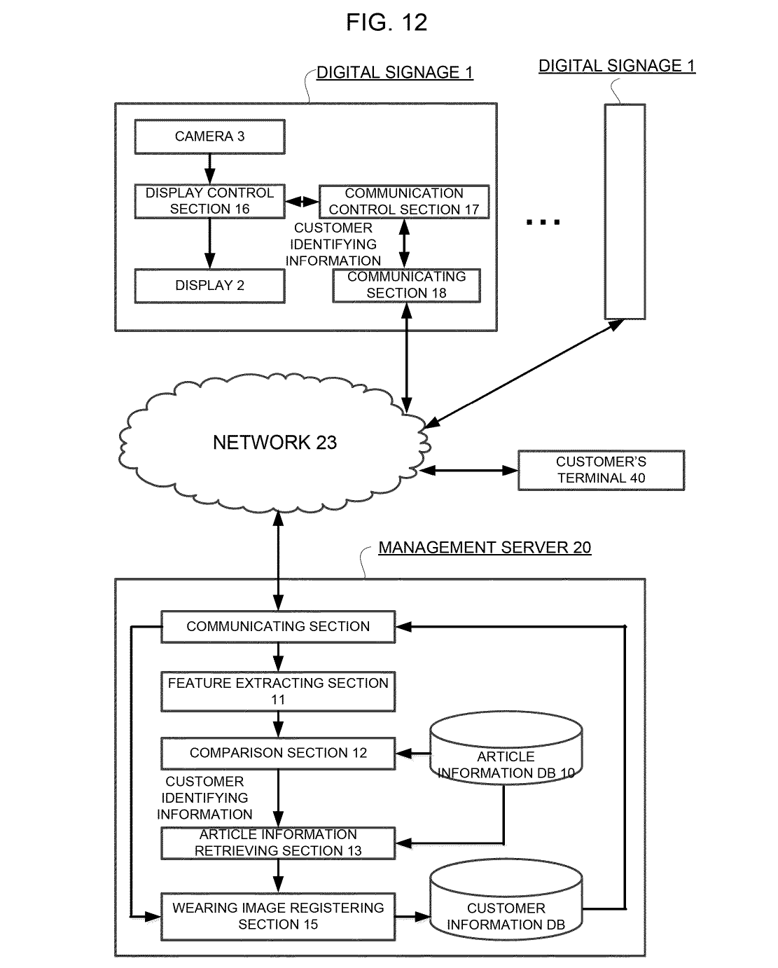

Moreover, the embodiment and exemplary embodiments are described merely by way of example, and they may be modified without departing from the scope of the present invention. For example, while the article information database 10, feature extracting section 11, comparison section 12, article information retrieving section 13, customer information database 19, and wearing image registering section 15 are configured to be incorporated into the digital signage 1 in the exemplary embodiments of the present invention, part or all of these components may be placed in an external server or the like. FIG. 12 shows an example of such a configuration.

In the example in FIG. 12, a management server 20 for conducting extraction of a feature, comparison, and registration processing for the product information and wearing image is provided, which is connected to the digital signage 1 via a communicating section 21. Transmission of the wearing image and product information to a customer's terminal is achieved by an e-mail or the like from the management server 20.

Advantages of the configuration above include reduced processing loads on the digital signage 1 by causing a server to execute processing with higher loads such as extraction of a feature, comparison, and product information retrieval processing. Moreover, by connecting a large number of sets of the digital signage 1 with the management server 20 via a network 23, product information such as stock may be integrally managed by the management server 20, so that a customer may be provided with product information reflecting not only information for the shop he/she is visiting but also information for other shops.

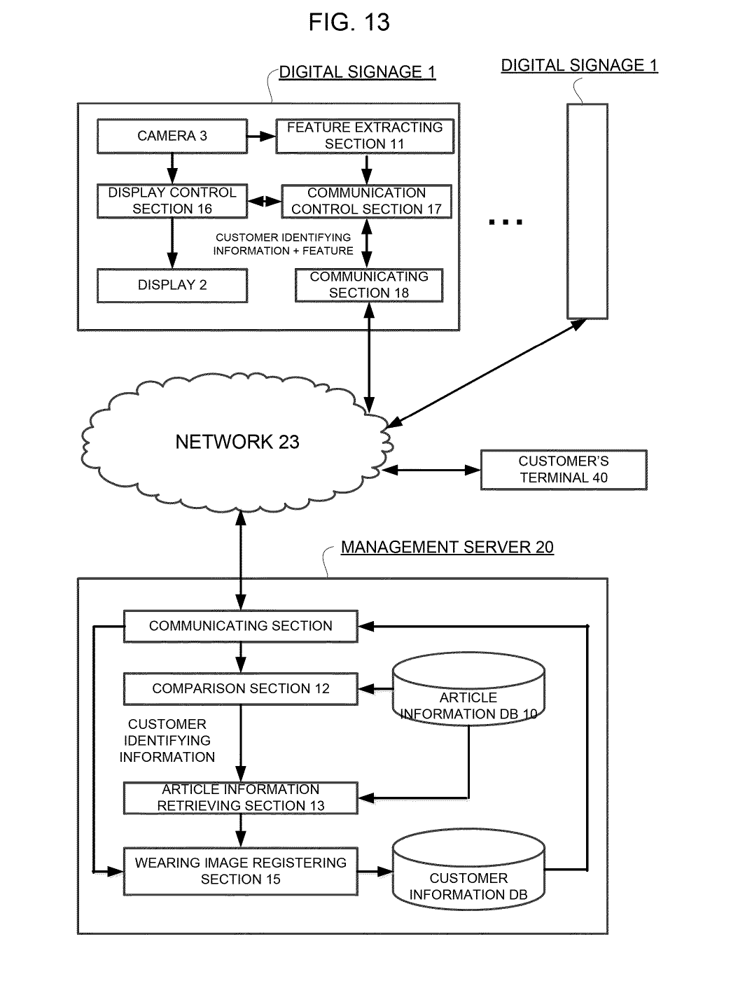

Moreover, as shown in FIG. 13, a feature may be extracted from a wearing image by the feature extracting section 11 at the digital signage 1, and the extracted feature and customer information may be transmitted to the management server 20. The management server 20 then conducts comparison, and product information and wearing image registration processing.

Advantages of this configuration include a smaller size of data to be transmitted because a feature, in place of image data of a customer, is transmitted from the digital signage 1; moreover, since an image in which a customer is directly captured is not transmitted, this configuration is also preferable in view of protection of customer's personally identifiable information.

Next, another embodiment will be described.

This embodiment has the digital signage system of the present invention in conjunction with a social network.

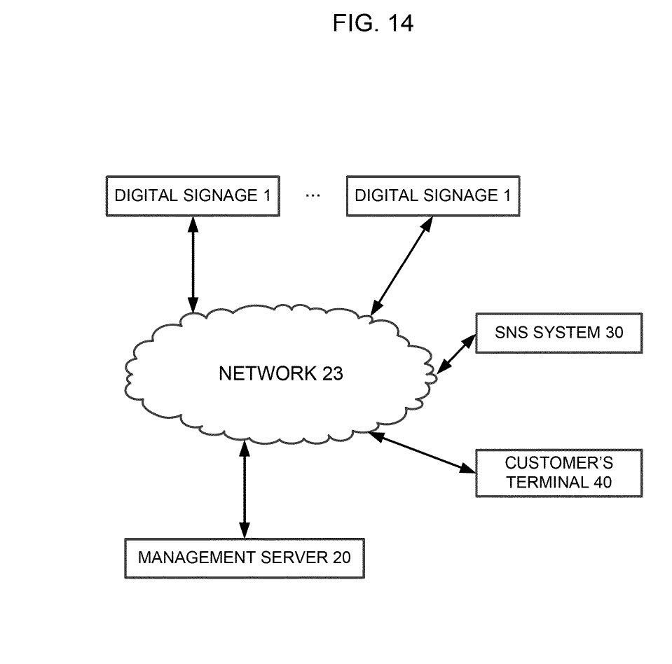

FIG. 14 is a configuration diagram of the present embodiment.

As shown in FIG. 14, the digital signage 1, a management server 20, an SNS system 30, and a customer's terminal 40 are connected with one another via a network 23.

The customer's terminal 40 is capable of transmitting a wearing image transmitted to the customer's terminal 40 to terminals of customer's friends/partner, or posting it to an SNS.

The customer can also use an application or a web site provided by a shop to ask the customer's friends/partner for feedback about the wearing image, for example, “Which do you like, this or that?”, “How's this? Look pretty?” or the like, or when the customer's friends/partner are asked the question above by the customer, or even though there is no question, when the customer posts the wearing image, they can reply their comments, such as “Like!/Could-be-better”.

Thus, by the conjunction with an SNS, or an application or a web site provided by a shop, a customer may be encouraged by his/her friends' comments to make a purchase, and a shop can collect talks about a product (direct reactions from customer's friends addressed to a customer).

Moreover, other usage may be contemplated, in which customer's friends or partner, instead of a customer, may specify a product by showing the product in a wearing image to a system provided by a shop using the wearing image as a key, and buy it for the customer. At that time, a duplicate purchase may be prevented, which is exemplified by a case that after the customer him/herself has already purchased the product, his/her friend buys the same product as a gift, or a case that a friend and another friend buy the same product.

For example, a shop registers purchase information for a product, for example, information indicating whether the product has not already been purchased, into the customer information database 19 in association with a wearing image or a feature of the wearing image. Thus, a friend receiving a transmitted wearing image can know whether the product has already been purchased, so that he/she can purchase the product for the customer without duplication.

Alternatively, a friend who has purchased a product may be allowed to notify a customer (the person in question) of the fact that the product in the wearing image has been purchased by means of an e-mail or the like.

At that time, to certify that the product in the wearing image has been purchased, a PURCHASED mark indicating that this product has been bought is superimposed over the wearing image so that it can be displayed on a customer's terminal. This may be implemented by a method involving displaying an image/video on the customer's terminal with the mark superimposed by an application, or transmitting a superimposed image/video to the customer using an electronic mail or the like. On the other hand, in a system at the shop, a combined image of the wearing image and PURCHASED mark may be generated, and a feature of the wearing image with the PURCHASED mark may be extracted and saved; thereafter, when the customer shows a wearing image with the PURCHASED mark presented on the customer's terminal to be read by the shop system, and the system compares the image with the saved feature, the wearing image is authenticated as an authorized wearing image with a PURCHASED mark, and the customer can then pick up the product purchased for him/her.

Thus, the customer (the person in question) may pick up the product by going to the shop and showing a notification on the terminal.

It should be noted that a shop may be one in which products are actually laid out and sold over the counter, or a virtual shop implemented by an application or on a web site provided by the shop. For the virtual shop, an on-line shopping service using a package delivery service or the like for picking up a product may be selected.

Now this is the end of the description of the embodiments of the present invention, wherein several components may be configured in hardware, and they also may be implemented by a computer program, as is obvious from the preceding description. In this case, a processor that is operated by programs stored in a program memory implements functions and/or operations similar to those in the embodiments described above. Moreover, only part of functions of the embodiments described above may be implemented by a computer program.

Part or all of the preceding embodiments may be described as in the following appendices, although not limited thereto.

### (Supplementary Note 1)

A digital signage system comprising:

an article information database in which a feature of an article and article information for said article associated with each other are stored;

feature extracting means for extracting a feature from a wearing image that is an image of a customer wearing an article;

comparison means for comparing said extracted feature with features stored in said article information database and identifying the article said customer is wearing;

article information retrieving means for retrieving article information for said identified article from said article information database; and

output control means for outputting said retrieved article information and said wearing image.

### (Supplementary Note 2)

The digital signage system as recited in Supplementary note 1, wherein:

said output control means transmits said wearing image to a customer's terminal

### (Supplementary Note 3)

The digital signage system as recited in Supplementary note 1 or 2, wherein:

said comparison means identifies a size of the article said customer is wearing, and

said article information retrieving means retrieves a stock of said article in that size from said article information database.

### (Supplementary Note 4)

The digital signage system as recited in any one of appendices 1 to 3, wherein:

a management server has at least said article information database, said comparison means, and article information retrieving means,

digital signage has at least said feature extracting means and output control means,

said digital signage transmits said extracted feature of an article to said comparison server, and

said management server transmits said article information to said digital signage based on said feature of an article.

### (Supplementary Note 5)

The digital signage system as recited in Supplementary note 4, wherein:

said wearing image and said product information are transmitted from said management server to said customer's terminal.

### (Supplementary Note 6)

Digital signage comprising:

an article information database in which a feature of an article and article information for said article associated with each other are stored;

feature extracting means for extracting a feature from a wearing image that is an image of a customer wearing an article;

comparison means for comparing said extracted feature with features stored in said article information database and identifying the article said customer is wearing;

article information retrieving means for retrieving article information for said identified article from said article information database; and

output control means for outputting said retrieved article information and said wearing image.

### (Supplementary Note 7)

An article information presenting method in a digital signage system having an article information database in which a feature of an article and article information for said article associated with each other are stored, said method comprising:

extracting a feature from a wearing image that is an image of a customer wearing an article;

comparing said extracted feature with features stored in said article information database and identifying the article said customer is wearing;

retrieving article information for said identified article from said article information database; and

outputting said retrieved article information and said wearing image.

### (Supplementary Note 8)

The article information presenting method as recited in Supplementary note 7, comprising:

transmitting said wearing image to a customer's terminal.

### (Supplementary Note 9)

The article information presenting method as recited in Supplementary note 7 or 8, comprising:

identifying a size of the article said customer is wearing, and retrieving and outputting a stock of the identified article in that size from said article information database.

### (Supplementary Note 10)

A program for a computer system having an article information database in which a feature of an article and article information for said article associated with each other are stored, said program for causing a computer to execute the processing of:

extracting a feature from a wearing image that is an image of a customer wearing an article;

comparing said extracted feature with features stored in said article information database and identifying the article said customer is wearing;

retrieving article information for said identified article from said article information database; and

outputting said retrieved article information and said wearing image.

### (Supplementary Note 11)

The program as recited in Supplementary note 10, causing a computer to execute the processing of:

transmitting said wearing image to a customer's terminal.

### (Supplementary Note 12)

The program as recited in Supplementary note 10 or 11, causing a computer to execute the processing of:

identifying a size of the article said customer is wearing, and retrieving and outputting a stock of the identified article in that size from said article information database.

While the present invention has been described with reference to the embodiments, it is not necessarily limited to the embodiments described above, and may be practiced with several modifications within a scope of the technical idea thereof. Moreover, the present invention may be practiced by combining these embodiments with one another as appropriate.

The present application claims priority based on Japanese Patent Application No. 2012-079082 filed on Mar. 30, 2012, disclosure of which is incorporated herein in its entirety.

### REFERENCE SIGNS LIST

1 Digital signage
2 Display
3 Camera
10 Article information database
11 Feature extracting section
12 Comparison section
13 Article information retrieving section
14 Output control section
15 Wearing image registering section
16 Display control section
17 Communication control section
18 Communicating section
19 Customer information database
20 Management server
21 Communicating section
23 Network
30 SNS system
40 Terminal

1. A digital signage system comprising:
an article information database in which a feature of an article and article information for said article associated with each other are stored;
feature extracting unit configured to extract a feature from a wearing image that is an image of a customer wearing an article;
comparison unit configured to compare said extracted feature with features stored in said article information database and identify the article said customer is wearing;
article information retrieving unit configured to retrieve article information for said identified article from said article information database; and
output control unit configured to output said retrieved article information and said wearing image.

2. The digital signage system according to claim 1, wherein:
said output control unit transmits said wearing image to a customer's terminal.

3. The digital signage system according to claim 1, wherein:
said comparison unit identifies a size of the article said customer is wearing, and
said article information retrieving unit retrieves a stock of said article in that size from said article information database.

4. The digital signage system according to claim 1, wherein:
a management server has at least said article information database, said comparison unit, and article information retrieving unit,
digital signage has at least said feature extracting unit and output control unit,
said digital signage transmits said extracted feature of an article to said management server, and
said management server transmits said article information to said digital signage based on said feature of an article.

5. The digital signage system according to claim 4, wherein:
said wearing image and said product information are transmitted from said management server to said customer's terminal.

6. Digital signage comprising:
an article information database in which a feature of an article and article information for said article associated with each other are stored;
feature extracting unit configured to extract a feature from a wearing image that is an image of a customer wearing an article;
comparison unit configured to compare said extracted feature with features stored in said article information database and identify the article said customer is wearing;
article information retrieving unit configured to retrieve article information for said identified article from said article information database; and
output control unit configured to output said retrieved article information and said wearing image.

7. An article information presenting method in a digital signage system having an article information database in which a feature of an article and article information for said article associated with each other are stored, said method comprising:
extracting a feature from a wearing image that is an image of a customer wearing an article;
comparing said extracted feature with features stored in said article information database and identifying the article said customer is wearing;
retrieving article information for said identified article from said article information database; and
outputting said retrieved article information and said wearing image.

8. The article information presenting method according to claim 7, comprising:
transmitting said wearing image to a customer's terminal.

9. The article information presenting method according to claim 7, comprising:
identifying a size of the article said customer is wearing, and retrieving and outputting a stock of the identified article in that size from said article information database.

10. A non-transitory computer readable storage medium storing a program for a computer system having an article information database in which a feature of an article and article information for said article associated with each other are stored, said program for causing a computer to execute the processing of:
extracting a feature from a wearing image that is an image of a customer wearing an article;
comparing said extracted feature with features stored in said article information database and identifying the article said customer is wearing;
retrieving article information for said identified article from said article information database; and
outputting said retrieved article information and said wearing image.

11. The digital signage according to claim 6, wherein:
said output control unit transmits said wearing image to a customer's terminal.

12. The digital signage according to claim 6, wherein:
said comparison unit identifies a size of the article said customer is wearing, and
said article information retrieving unit retrieves a stock of said article in that size from said article information database.

13. The non-transitory computer readable storage medium storing a program according to claim 10, causing a computer to execute the processing of:
transmitting said wearing image to a customer's terminal.

14. The non-transitory computer readable storage medium storing a program according to claim 10, causing a computer to execute the processing of:
identifying a size of the article said customer is wearing, and retrieving and outputting a stock of the identified article in that size from said article information database.
